(19) United States
(12) Patent Application Publication
(10) Pub. No.: US 2024/0198548 A1
(43) Pub. Date: Jun. 20, 2024

(54) Manual Razor Having Temperature-changing Function

(71) Applicant: Ningbo Kaili Holding Group Co., Ltd, Ningbo (CN)

(72) Inventors: Zhufeng Bao, Ningbo (CN); Jian Lin, Ningbo (CN)

(21) Appl. No.: 18/592,890

(22) Filed: Mar. 1, 2024

Related U.S. Application Data
(63) Continuation of application No. PCT/CN2022/119041, filed on Sep. 15, 2022.

(30) Foreign Application Priority Data
Sep. 17, 2021 (CN) 202122260532.7
Sep. 17, 2021 (CN) 202122261417.1
Sep. 17, 2021 (CN) 202122261441.5

(51) Int. Cl. B26B 21/48; B26B 21/40; B26B 21/52

(52) U.S. Cl. CPC B26B 21/48; B26B 21/4056; B26B 21/4062; B26B 21/526

(57) ABSTRACT

Provided is a manual razor having a temperature-changing function. The handle is provided with the heat transfer structure having both heating and refrigeration functions, or the refrigeration structure only having a refrigeration function, or the heating structure only having a heating function, and the heat transfer structure, the refrigeration structure or the heating structure is directly connected to the blade in a heat conduction mode, so that the temperature of the blade for shaving is changed along with the change of the temperature of the heat transfer structure, the refrigeration structure or the heating structure. Moreover, the razor has few structural components and is low in cost, compact in overall structure, and small in occupied space.

### CROSS REFERENCE TO RELATED APPLICATIONS

The present application is a Continuation Application of PCT Application No. PCT/CN2022/119041 filed on Sep. 15, 2022, which claims the benefit of Chinese Patent Application Nos. 202122260532.7, 202122261441.5 and 202122261417.1 filed on Sep. 17, 2021. All the above are hereby incorporated by reference in their entirety.

### TECHNICAL FIELD

The present invention relates to the technical field of hair trimmers, and in particular to a manual razor having a temperature-changing function.

### BACKGROUND

Existing manual razors generally include cartridge assemblies and handle assemblies connected to each other. The cartridge assemblies are provided with blades for shaving. The manual razors are easy to operate and effective in shaving, and therefore, are very popular among men. With the development of economy, more and more people pay more attention to the usage experience of manual razors, for example, the heating and refrigeration functions of the manual razors, so that the user can warm or cool the skin by using the manual razors during shaving. However, the existing manual razors generally realize the warming or cooling effect by adding temperature-changing components near the blades, which increases the components, cost and overall volume, causing an increase in occupied space.

### SUMMARY

In order to solve at least one of the above problems, the present invention provides a manual razor having a temperature-changing function, including a handle and a blade rest connected to each other. A blade is mounted on the blade rest; and the handle is provided with a heat transfer structure configured to heat or refrigerate, and the heat transfer structure and the blade are connected to each other in a heat conduction mode; or the handle is provided with a refrigeration structure, and the refrigeration structure and the blade are connected to each other in a heat conduction mode; or the handle is provided with a heating structure, and the heating structure and the blade are connected to each other in a heat conduction mode. The blade is connected with a heat conduction bracket, and the blade is connected to the heat transfer structure in the heat conduction mode through the heat conduction bracket; or the blade is connected to the refrigeration structure in the heat conduction mode through the heat conduction bracket; or the blade is connected to the heating structure in the heat conduction mode through the heat conduction bracket.

Optionally, the handle and the blade rest are hinged with each other.

Optionally, the blade is integrally formed with the heat conduction bracket.

Optionally, the heat transfer structure includes a circuit board, a heating body, a refrigerating body, and a heat conduction assembly connected to the blade. The heating body and the refrigerating body are both electrically connected to the circuit board and connected to the heat conduction assembly in a heat conduction mode.

Optionally, the heating body is a heating semiconductor, and the refrigerating body is a refrigerating semiconductor.

Optionally, the heat conduction assembly includes an aluminum conductive sheet and a sheet metal connector connected to each other. The sheet metal connector abuts against the blade.

Optionally, the heat conduction assembly further includes a copper conductive sheet. The copper conductive sheet is arranged between the aluminum conductive sheet and the heating body and refrigerating body.

Optionally, a battery configured to power the circuit board is further arranged in the handle, and the handle is provided with a battery level display lamp connected to the circuit board.

Optionally, the handle is further provided with a switch button connected to the circuit board. The switch button includes a heating button and a refrigeration button.

Optionally, the refrigeration structure includes a first circuit board, a first refrigerating body, and a first heat conduction assembly connected to the blade. The first refrigerating body is electrically connected to the first circuit board and connected to the first heat conduction assembly in a heat conduction mode.

Optionally, the first refrigerating body is a refrigerating semiconductor, and the refrigerating semiconductor is connected with a first heat dissipater.

Optionally, the first heat conduction assembly includes a first aluminum conductive sheet connected to the first refrigerating body in a heat conduction mode.

Optionally, the first heat conduction assembly further includes a first sheet metal connector connected to the first aluminum conductive sheet. The first sheet metal connector abuts against the blade. The handle and the blade rest are hinged with each other.

Optionally, the first heat conduction assembly further includes a first copper conductive sheet. The first copper conductive sheet is arranged between the first aluminum conductive sheet and the first refrigerating body.

Optionally, a battery configured to power the first circuit board is further arranged in the handle, and the handle is provided with a battery level display lamp connected to the first circuit board.

Optionally, the handle is further provided with a switch button connected to the first circuit board.

Optionally, the heating structure includes a second circuit board, a second heating body, and a second heat conduction assembly connected to the blade. The second heating body is electrically connected to the second circuit board and connected to the second heat conduction assembly in a heat conduction mode.

Optionally, the second heating body is a heating semiconductor.

Optionally, a battery configured to power the second circuit board is further arranged in the handle, and the handle is provided with a battery level display lamp connected to the second circuit board.

Optionally, the handle is further provided with a switch button connected to the second circuit board.

Optionally, the second heat conduction assembly includes a second aluminum conductive sheet and a second sheet metal connector connected to each other. The second sheet metal connector abuts against the blade.

Optionally, the second heat conduction assembly further includes a second copper conductive sheet. The second copper conductive sheet is arranged between the second aluminum conductive sheet and the second heating body.

Compared with the prior art, in the manual razor having a temperature-changing function in the present invention, the handle is provided with the heat transfer structure having both heating and refrigeration functions, or the refrigeration structure only having a refrigeration function, or the heating structure only having a heating function, and the heat transfer structure, the refrigeration structure or the heating structure is directly connected to the blade in the heat conduction mode, so that the temperature of the blade for shaving is changed along with the change of the temperature of the heat transfer structure, the refrigeration structure or the heating structure. In this way, the user can enable the heating function in cold winter, so that the warm blade can reduce irritations to the skin and help in expanding skin pores, making the manual razor have a better shaving effect. Similarly, the user can enable the refrigeration function in hot summer, so that the cool blade can reduce the sensitivity of the skin and shrink the skin pores through cold feeling of the blade, thereby making the user feel less hot and burning after shaving. The razor with this structural design has few structural components and is low in cost, compact in overall structure, and small in occupied space.

### BRIEF DESCRIPTION OF FIGURES

FIG. 1 is a sectional view of a manual razor according to an embodiment of the present invention;

FIG. 2 is an enlarged view of A in FIG. 1;

FIG. 3 is a structural view of a manual razor according to an embodiment of the present invention;

FIG. 4 is a structural view of a blade fitted with a sheet metal connector according to an embodiment of the present invention;

FIG. 5 is a sectional view of a manual razor only having a refrigeration function according to an embodiment of the present invention;

FIG. 6 is an enlarged view of B in FIG. 5;

FIG. 7 is a structural view of a manual razor only having a refrigeration function according to an embodiment of the present invention;

FIG. 8 is a structural view of a blade fitted with a sheet metal connector in a manual razor only having a refrigeration function according to an embodiment of the present invention;

FIG. 9 is a sectional view of a manual razor only having a heating function according to an embodiment of the present invention;

FIG. 10 is an enlarged view of C in FIG. 9;

FIG. 11 is a structural view of a manual razor only having a heating function according to an embodiment of the present invention; and

FIG. 12 is a structural view of a blade fitted with a sheet metal connector in a manual razor only having a heating function according to an embodiment of the present invention.

### DESCRIPTION OF REFERENCE NUMERALS

1, handle; 11, battery level display lamp; 12, switch button; 121, heating button; 122, refrigeration button; 2, blade rest; 3, blade; 31, heat conduction bracket; 4, heat transfer structure; 41, circuit board; 42, heat conduction assembly; 421, aluminum conductive sheet; 422, sheet metal connector; 423, copper conductive sheet; 43, heating body; 44, refrigerating body; 45, heat dissipater; 5, battery; 6, refrigeration structure; 61, first circuit board; 62, first heat conduction assembly; 621, first aluminum conductive sheet; 622, first sheet metal connector; 623, first copper conductive sheet; 63, first heat dissipater; 64, first refrigerating body; 7, heating structure; 71, second circuit board; 72, second heat conduction assembly; 721, second aluminum conductive sheet; 722, second sheet metal connector; 723, second copper conductive sheet; and 73, second heating body.

### DETAILED DESCRIPTION

To make the foregoing objectives, features, and advantages of the present invention more apparent and easier to understand, specific embodiments of the present invention are described in detail below with reference to the accompanying drawings.

In the description of the present invention, it should be understood that the orientation or positional relationship indicated by the terms “upper”, “lower”, etc. is based on the orientation or positional relationship of the product during normal use.

The terms “first” and “second” are merely used for descriptive purposes, and cannot be understood as indicating or implying relative importance or implicitly indicating the number of technical features indicated. Therefore, the features defined with “first” and “second” may explicitly or implicitly include at least one such feature.

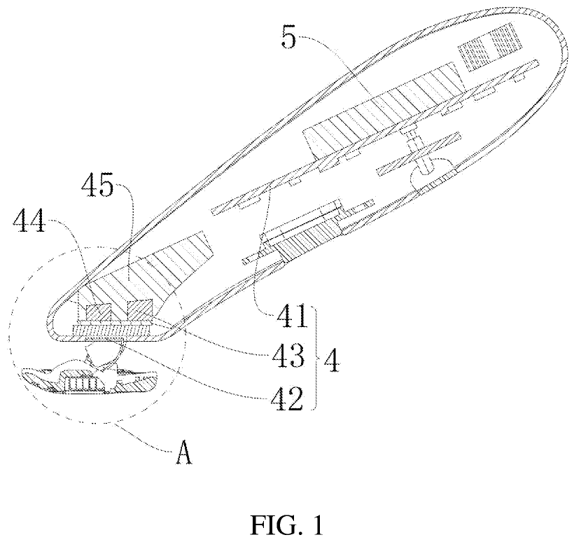

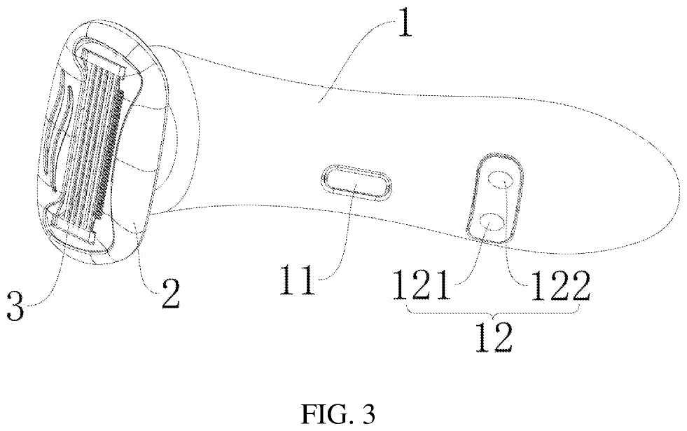

An embodiment of the present invention provides a manual razor having a temperature-changing function, as shown in FIG. 1 and FIG. 3, including a handle 1 and a blade rest 2 connected to each other. Blades 3 are mounted on the blade rest 2. The handle 1 is provided with a heat transfer structure 4 configured to heat or refrigerate, and the heat transfer structure 4 and the blades 3 are connected to each other in a heat conduction mode.

The blades 3 are made of a thermally conductive material such as metal or ceramic, which has good thermal conductivity. The handle 1 is configured to be held by a user. The blade rest 2 is mounted at one end of the handle 1. The handle 1 and the blade rest 2 are generally made of an insulating material such as plastic. The heat transfer structure 4 may be controlled to carry out heating or refrigeration, which may be specifically selected according to needs of the user. The temperature of the blades 3 may be changed along with the change of the temperature of the heat transfer structure 4, so that the blades 3 can be heated or cooled through the heating or refrigeration of the heat transfer structure 4.

According to the manual razor having a temperature-changing function in this embodiment, the handle 1 is provided with the heat transfer structure 4 having the heating and refrigeration functions, and the heat transfer structure 4 is directly connected to the blades 3 in a heat conduction mode, so that the temperature of the blades 3 for shaving is changed along with the change of the temperature of the heat transfer structure 4. In this way, the user can enable the heating function in cold winter, so that the warm blades 3 can reduce irritations to the skin and help in expanding skin pores, making the manual razor have a better shaving effect. Similarly, the user can enable the refrigeration function in hot summer, so that the cool blades 3 can reduce the sensitivity of the skin and shrink the skin pores through cold feeling of the blades 3, thereby making the user feel less hot and burning after shaving. The razor with this structural design has few structural components and is low in cost, compact in overall structure, and small in occupied space.

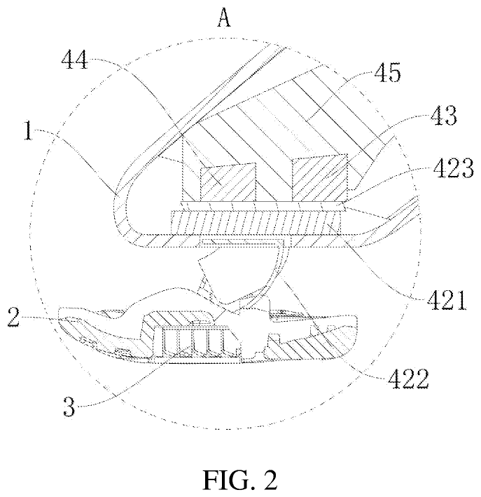

Optionally, as shown in FIG. 1 and FIG. 2, the handle 1 and the blade rest 2 are hinged with each other.

Two sides of one end of the handle 1 are respectively provided with rotating shafts, and the blade rest 2 is provided with mounting holes fitted with the rotating shafts. After the rotating shafts are fitted with the mounting holes, the blade rest 2 can rotate with respect to the handle 1 when stressed. In this embodiment, the handle 1 and the blade rest 2 are designed to be hinged with each other, so that the blade rest 2 provided with the blades 3 can rotate with respect to the handle 1, which facilitates the shaving of the user at various positions.

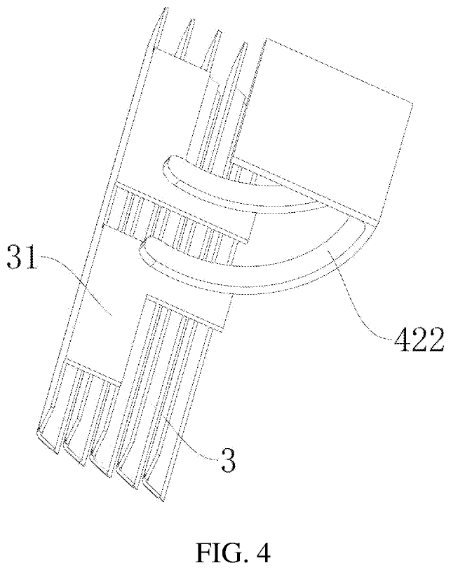

Optionally, as shown in FIG. 1, FIG. 2 and FIG. 4, the blades 3 are connected with heat conduction brackets 31, and the blades 3 are connected to the heat transfer structure 4 in the heat conduction mode through the heat conduction brackets 31.

Multiple blades 3 are provided, and the blades 3 are arranged in parallel with each other at intervals. Two heat conduction brackets 31 are provided, each having a 7-shaped structure. Each heat conduction bracket 31 is connected to each blade 3, so that energy received by the heat conduction brackets 31 can be effectively transferred to each blade 3, and the mass of the overall structure of the blades 3 and the heat conduction brackets 31 can be minimized. The heat conduction brackets 31 are made of a thermally conductive material such as metal or ceramic, which has good thermal conductivity. In this embodiment, the heat conduction brackets 31 are additionally arranged between the blades 3 and the heat transfer structure 4, so that the change of the temperature of the blades 3 is more stable and uniform when heated or cooled.

Optionally, as shown in FIG. 4, the blades 3 are integrally formed with the heat conduction brackets 31.

One of the blades 3 is integrally formed with the heat conduction brackets 31, and the other blades 3 may be connected to the heat conduction brackets 31 by welding or bonding, which can reduce the mounting steps and ensure the heat transfer effect between the blades 3 and the heat conduction brackets 31.

Optionally, as shown in FIG. 1 and FIG. 2, the heat transfer structure 4 includes a circuit board 41, a heating body 43, a refrigerating body 44, and a heat conduction assembly 42 connected to the blades 3. The heating body 43 and the refrigerating body 44 are both electrically connected to the circuit board 41 and connected to the heat conduction assembly 42 in a heat conduction mode.

When the blades 3 need to be heated, the circuit board 41 controls the heating body 43 to carry out heating. When a certain temperature is reached, energy on the heating body 43 is conducted to the heat conduction assembly 42, the temperature of the heat conduction assembly 42 rises, and energy on the heat conduction assembly 42 is transferred to the blades 3, so that the temperature of the blades 3 finally rises. Similarly, when the blades 3 need to the cooled, the circuit board 41 controls the refrigerating body 44 to carry out refrigeration. When a certain temperature is reached, energy on the heat conduction assembly 42 is absorbed to the refrigerating body 44, the temperature of the heat conduction assembly 42 drops, and energy on the blades 3 is absorbed to the heat conduction assembly 42, so that the temperature of the blades 3 finally drops.

Optionally, as shown in FIG. 1 and FIG. 2, the heating body 43 is a heating semiconductor, and the refrigerating body 44 is a refrigerating semiconductor.

The heating of the heating semiconductor and the refrigeration of the refrigerating semiconductor are both the results of applying the thermoelectric effect, and the heating semiconductor and the refrigerating semiconductor are respectively formed by connecting two ends of two different semiconductors. When a current flows through the heating semiconductor, one end becomes hot and the other end becomes cool, so that a temperature difference is produced, that is, one end performs a heating function and the other end performs a refrigeration function, and the heating end of the heating semiconductor is connected to the heat conduction assembly 42. Similarly, when a current flows through the refrigerating semiconductor, one end becomes hot and the other end becomes cool, so that a temperature difference is produced, that is, one end performs a heating function and the other end performs a refrigeration function, and the refrigeration end of the refrigerating semiconductor is connected to the heat conduction assembly 42. The heating end of the refrigerating semiconductor is further connected with a heat dissipater 45, so as to prevent the semiconductor from damage and ensure the service life of the semiconductor. The heat dissipater 45 is generally made of aluminum, which has the advantages of light weight, low price and good heat dissipation effect.

Optionally, as shown in FIG. 1, FIG. 2 and FIG. 4, the heat conduction assembly 42 includes an aluminum conductive sheet 421 and a sheet metal connector 422 connected to each other. The sheet metal connector 422 abuts against the blades 3.

The aluminum conductive sheet 421 is made of aluminum, which has the advantages of light weight, low cost and good thermal conductivity and is less susceptible to oxidation. In addition, other materials with good thermal conductivity are also available. The sheet metal connector 422 is made of stainless steel by sheet metal working, has certain elasticity and toughness, and is in the shape of a curved horseshoe. While the blade rest 2 rotates with respect to the handle 1, the sheet metal connector 422 can be always in contact with the heat conduction brackets 31 on the blades 3. The sheet metal connector 422 is thermally conductive, and can conduct heat with the blades 3.

In this embodiment, the sheet metal connector 422 is arranged. On the one hand, the sheet metal connector 422 has certain elasticity and toughness, so that the blade rest 2 can smoothly rotate with respect to the handle 1, and therefore, the blade rest 2 can be designed into a structure that can rotate with respect to the handle 1, which facilitates the user. On the other hand, the sheet metal connector 422 has good thermal conductivity, so that the heat conduction structure can be always in contact with the blades 3 while the blade rest 2 rotates with respect to the handle 1, thereby effectively controlling the blades 3 to become hot or cool.

Optionally, as shown in FIG. 1 and FIG. 2, the heat conduction assembly 42 further includes a copper conductive sheet 423. The copper conductive sheet 423 is arranged between the aluminum conductive sheet 421 and the heating body 43 and refrigerating body 44.

The heating body 43 and the refrigerating body 44 are arranged side by side, and sides of the heating body and the refrigerating body close to the aluminum conductive sheet 421 are flush with each other. The copper conductive sheet 423 is a copper sheet, which is generally rectangular or circular and is low in cost. In addition, other materials with good thermal conductivity are also available. The copper sheet has good heat conduction effect. Moreover, the copper sheet is soft and has certain ductility, and can be stretched when the aluminum conductive sheet 421, and the heating body 43 and the refrigerating body 44 squeeze each other, so that contact areas of two side surfaces of the copper sheet with the aluminum conductive sheet 421, and the heating body 43 and the refrigerating body 44 are maximized, which prevents the loss of energy during the transfer process, thereby ensuring a better overall heat conduction effect and improving the energy transfer efficiency.

Optionally, as shown in FIG. 1, FIG. 2 and FIG. 3, a battery 5 configured to power the circuit board 41 is further arranged in the handle 1, and the handle 1 is provided with a battery level display lamp 11 connected to the circuit board 41.

The battery 5 is a rechargeable battery 5. The battery level display lamp 11 is configured to display a battery 5 level. The battery level display lamp 11 is exposed outside a casing of the handle 1, so that the user can observe the use of the battery 5 in time and charge the battery in time conveniently.

Optionally, as shown in FIG. 1, FIG. 2 and FIG. 3, the handle 1 is further provided with a switch button 12 connected to the circuit board 41. The switch button 12 includes a heating button 121 and a refrigeration button 122.

The heating button 121 and the refrigeration button 122 are exposed outside a surface of the casing of the handle 1. When the blades 3 need to be heated, the user presses the heating button 121, and the circuit board 41 controls the heating body 43 to carry out heating. When a certain temperature is reached, the energy on the heating body 43 is conducted to the copper conductive sheet 423, the copper conductive sheet 423 transfers the energy to the aluminum conductive sheet 421, the aluminum conductive sheet 421 conducts the energy to the sheet metal connector 422, and the energy on the sheet metal connector 422 is transferred to the blades 3, so that the temperature of the blades 3 finally rises. Similarly, when the blades 3 need to be cooled, the user presses the refrigeration button 122, the circuit board 41 controls the refrigerating body 44 to carry out refrigeration. When a certain temperature is reached, the energy on the copper conductive sheet 423 is absorbed to the refrigerating body 44, the temperature of the copper conductive sheet 423 drops, the energy of the aluminum conductive sheet 421 is absorbed to the copper conductive sheet 423, the temperature of the aluminum conductive sheet 421 drops, the energy of the sheet metal connector 422 is absorbed to the aluminum conductive sheet 421, the temperature of the sheet metal connector 422 drops, and the energy on the blades 3 is absorbed to the sheet metal connector 422, so that the temperature of the blades 3 finally drops.

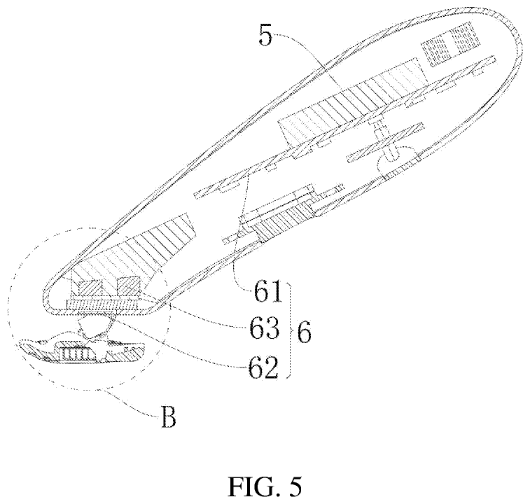

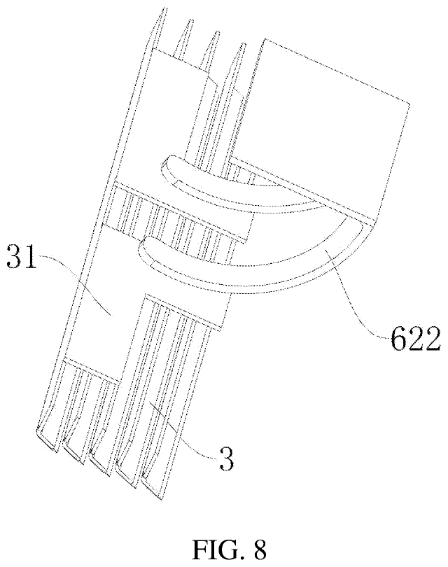

An embodiment of the present invention further provides a manual razor having a temperature-changing function, as shown in FIG. 5 and FIG. 7, including a handle 1 and a blade rest 2 connected to each other. Blades 3 are mounted on the blade rest 2. The handle 1 is provided with a refrigeration structure 6, and the refrigeration structure 6 and the blades 3 are connected to each other in a heat conduction mode.

The blades 3 are made of a thermally conductive material such as metal or ceramic, which has good thermal conductivity. The handle 1 is configured to be held by a user. The blade rest 2 is mounted at one end of the handle 1. The handle 1 and the blade rest 2 are generally made of an insulating material such as plastic. The refrigeration structure 6 may be controlled to carry out refrigeration. The temperature of the blades 3 may be changed along with the change of the temperature of the refrigeration structure 6, so that the blades 3 can be cooled through the refrigeration of the refrigeration structure 6.

According to the manual razor having a temperature-changing function in this embodiment, the handle 1 is provided with the refrigeration structure 6 having the refrigeration function, and the refrigeration structure 6 is directly connected to the blades 3 in a heat conduction mode, so that the temperature of the blades 3 for shaving is changed along with the change of the temperature of the refrigeration structure 6. Therefore, the user can enable the refrigeration function in hot summer, so that the cool blades 3 can reduce the sensitivity of the skin and shrink the skin pores through cold feeling of the blades 3, thereby making the user feel less hot and burning after shaving. The razor with this structural design has few structural components and is low in cost, compact in overall structure, and small in occupied space.

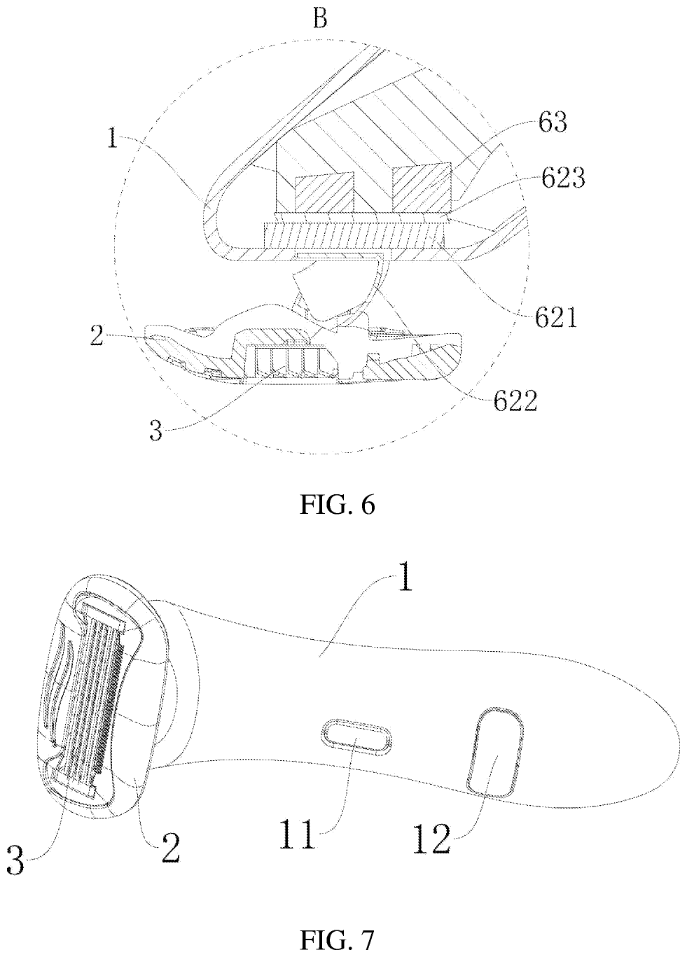

Optionally, as shown in FIG. 5, FIG. 6 and FIG. 8, the blades 3 are connected with heat conduction brackets 31, and the blades 3 are connected to the refrigeration structure 6 in the heat conduction mode through the heat conduction brackets 31.

Multiple blades 3 are provided, and the blades 3 are arranged in parallel with each other at intervals. Two heat conduction brackets 31 are provided, each having a 7-shaped structure. Each heat conduction bracket 31 is connected to each blade 3, so that energy received by the heat conduction brackets 31 can be effectively transferred to each blade 3, and the mass of the overall structure of the blades 3 and the heat conduction brackets 31 can be minimized. The heat conduction brackets 31 are made of a thermally conductive material such as metal or ceramic, which has good thermal conductivity. In this embodiment, the heat conduction brackets 31 are additionally arranged between the blades 3 and the refrigeration structure 6, so that the change of the temperature of the blades 3 is more stable and uniform when heated or cooled.

Optionally, as shown in FIG. 5, FIG. 6 and FIG. 8, the blades 3 are integrally formed with the heat conduction brackets 31.

One of the blades 3 is integrally formed with the heat conduction brackets 31, and the other blades 3 may be connected to the heat conduction brackets 31 by welding or bonding, which can reduce the mounting steps and ensure the heat transfer effect between the blades 3 and the heat conduction brackets 31.

Optionally, as shown in FIG. 5 and FIG. 6, the refrigeration structure 6 includes a first circuit board 61, first refrigerating bodies 64 and a first heat conduction assembly 62 connected to the blades 3. The first refrigerating bodies 64 are electrically connected to the first circuit board 61 and connected to the first heat conduction assembly 62 in a heat conduction mode.

When the blades 3 need to the cooled, the first circuit board 61 controls the first refrigerating bodies 64 to carry out refrigeration. When a certain temperature is reached, energy on the first heat conduction assembly 62 is absorbed to the first refrigerating bodies 64, the temperature of the first heat conduction assembly 62 drops, and energy on the blades 3 is absorbed to the first heat conduction assembly 62, so that the temperature of the blades 3 finally drops.

Optionally, as shown in FIG. 5 and FIG. 6, the first refrigerating bodies 64 are refrigerating semiconductors, and the refrigerating semiconductors are connected with a first heat dissipater 63.

The refrigeration of the refrigerating semiconductor is the result of applying the thermoelectric effect. When a current flows through the refrigerating semiconductor, one end becomes hot and the other end becomes cool, so that a temperature difference is produced, that is, one end performs a heating function and the other end performs a refrigeration function, and the refrigeration end of the refrigerating semiconductor is connected to the first heat conduction assembly 62. The heating end of the refrigerating semiconductor is further connected with the first heat dissipater 63, so as to prevent the semiconductor from damage and ensure the service life of the semiconductor. The first heat dissipater 63 is generally made of aluminum, which has the advantages of light weight, low price and good heat dissipation effect.

Optionally, as shown in FIG. 5 and FIG. 6, the first heat conduction assembly 62 includes a first aluminum conductive sheet 621 connected to the first refrigerating bodies 64 in a heat conduction mode.

The first aluminum conductive sheet 621 is made of aluminum, which has the advantages of light weight, low cost and good thermal conductivity and is less susceptible to oxidation. In addition, other materials with good thermal conductivity are also available. The first sheet metal connector 622 is made of stainless steel by sheet metal working, has certain elasticity and toughness, and is in the shape of a curved horseshoe. While the blade rest 2 rotates with respect to the handle 1, the first sheet metal connector 622 can be always in contact with the heat conduction brackets 31 on the blades 3. The first sheet metal connector 622 is thermally conductive, and can conduct heat with the blades 3.

In this embodiment, the first sheet metal connector 622 is arranged. On the one hand, the first sheet metal connector 622 has certain elasticity and toughness, so that the blade rest 2 can smoothly rotate with respect to the handle 1, and therefore, the blade rest 2 can be designed into a structure that can rotate with respect to the handle 1, which facilitates the user. On the other hand, the first sheet metal connector 622 has good thermal conductivity, so that the heat conduction structure can be always in contact with the blades 3 while the blade rest 2 rotates with respect to the handle 1, thereby effectively controlling the blades 3 to become cool.

Optionally, as shown in FIG. 5, FIG. 6 and FIG. 8, the first heat conduction assembly 62 further includes a first sheet metal connector 622 connected to the first aluminum conductive sheet 621. The first sheet metal connector 622 abuts against the blades 3, and the handle 1 and the blade rest 2 are hinged with each other.

Two sides of one end of the handle 1 are respectively provided with rotating shafts, and the blade rest 2 is provided with mounting holes fitted with the rotating shafts. After the rotating shafts are fitted with the mounting holes, the blade rest 2 can rotate with respect to the handle 1 when stressed. In this embodiment, the handle 1 and the blade rest 2 are designed to be hinged with each other, so that the blade rest 2 provided with the blades 3 can rotate with respect to the handle 1, which facilitates the shaving of the user at various positions.

Optionally, as shown in FIG. 5 and FIG. 6, the first heat conduction assembly 62 further includes a first copper conductive sheet 623. The first copper conductive sheet 623 is arranged between the first aluminum conductive sheet 621 and the first refrigerating bodies 64.

Two first refrigerating bodies 64 arranged side by side are provided, and sides of the first refrigerating bodies close to the first aluminum conductive sheet 621 are flush with each other. The first copper conductive sheet 623 is a copper sheet, which is generally rectangular or circular and is low in cost. In addition, other materials with good thermal conductivity are also available. The copper sheet has good heat conduction effect. Moreover, the copper sheet is soft and has certain ductility, and can be stretched when the first aluminum conductive sheet 621 and the first refrigerating bodies 64 squeeze each other, so that contact areas of two side surfaces of the copper sheet with the first aluminum conductive sheet 621 and the first refrigerating bodies 64 are maximized, which prevents the loss of energy during the transfer process, thereby ensuring a better overall heat conduction effect and improving the energy transfer efficiency.

Optionally, as shown in FIG. 5, FIG. 6 and FIG. 7, a battery 5 configured to power the first circuit board 61 is further arranged in the handle 1, and the handle 1 is provided with a battery level display lamp 11 connected to the first circuit board 61.

The battery 5 is a rechargeable battery 5. The battery level display lamp 11 is configured to display a battery 5 level. The battery level display lamp 11 is exposed outside a casing of the handle 1, so that the user can observe the use of the battery 5 in time and charge the battery in time conveniently.

Optionally, as shown in FIG. 5, FIG. 6 and FIG. 7, the handle 1 is further provided with a switch button 12 connected to the first circuit board 61.

The switch button 12 is exposed outside a surface of the casing of the handle 1. When the blades 3 need to be cooled, the user presses the switch button 12, the first circuit board 61 controls the first refrigerating bodies 64 to carry out refrigeration. When a certain temperature is reached, the energy on the first copper conductive sheet 623 is absorbed to the first refrigerating bodies 64, the temperature of the first copper conductive sheet 623 drops, the energy of the first aluminum conductive sheet 621 is absorbed to the first copper conductive sheet 623, the temperature of the first aluminum conductive sheet 621 drops, the energy of the first sheet metal connector 622 is absorbed to the first aluminum conductive sheet 621, the temperature of the first sheet metal connector 622 drops, and the energy on the blades 3 is absorbed to the first sheet metal connector 622, so that the temperature of the blades 3 finally drops.

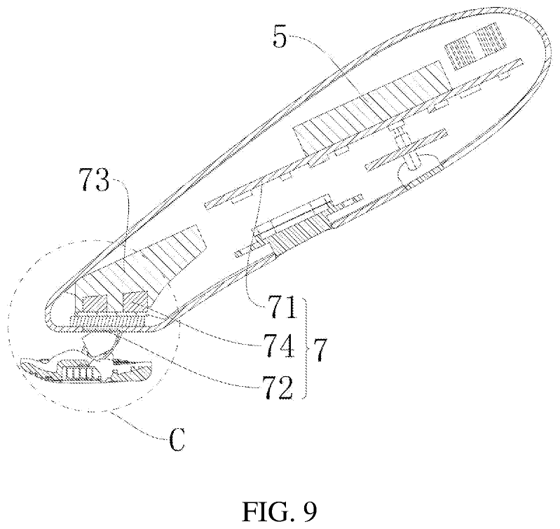

An embodiment of the present invention provides a manual razor having a temperature-changing function, as shown in FIG. 9 and FIG. 11, including a handle 1 and a blade rest 2 connected to each other. Blades 3 are mounted on the blade rest 2. The handle 1 is provided with a heating structure 7, and the heating structure 7 and the blades 3 are connected to each other in a heat conduction mode.

The blades 3 are made of a thermally conductive material such as metal or ceramic, which has good thermal conductivity. The handle 1 is configured to be held by a user. The blade rest 2 is mounted at one end of the handle 1. The handle 1 and the blade rest 2 are generally made of an insulating material such as plastic. The heating structure 7 may be controlled to carry out heating, which may be specifically selected according to needs of the user. The temperature of the blades 3 may be changed along with the change of the temperature of the heating structure 7, so that the blades 3 can be heated through the heating of the heating structure 7.

According to the manual razor having a temperature-changing function in this embodiment, the handle 1 is provided with the heating structure 7 having the heating function, and the heating structure 7 is directly connected to the blades 3 in a heat conduction mode, so that the temperature of the blades 3 for shaving is changed along with the change of the temperature of the heating structure 7. In this way, the user can enable the heating function in cold winter, so that the warm blades 3 can reduce irritations to the skin and help in expanding skin pores, making the manual razor have a better shaving effect. The razor with this structural design has few structural components and is low in cost, compact in overall structure, and small in occupied space.

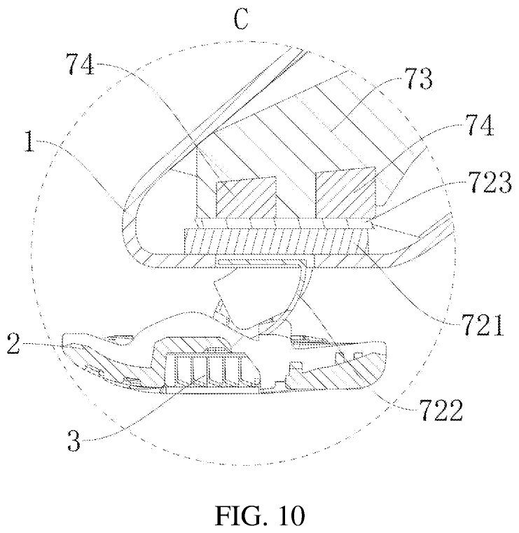

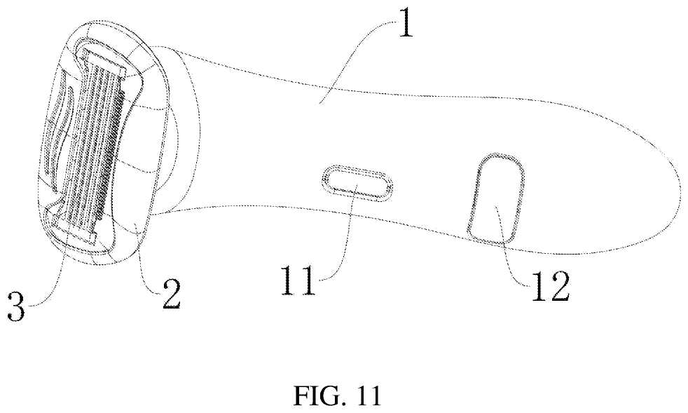

Optionally, as shown in FIG. 9, FIG. 10 and FIG. 11, the heating structure 7 includes a second circuit board 71, second heating bodies 73, and a second heat conduction assembly 72 connected to the blades 3. The second heating bodies 73 are electrically connected to the second circuit board 71 and connected to the second heat conduction assembly 72 in a heat conduction mode.

When the blades 3 need to be heated, the second circuit board 71 controls the second heating bodies 73 to carry out heating. When a certain temperature is reached, energy on the second heating bodies 73 is conducted to the second heat conduction assembly 72, the temperature of the second heat conduction assembly 72 rises, and energy on the second heat conduction assembly 72 is transferred to the blades 3, so that the temperature of the blades 3 finally rises.

Optionally, as shown in FIG. 9 and FIG. 10, the second heating bodies 73 are heating semiconductors.

The heating of the heating semiconductor is the result of applying the thermoelectric effect. When a current flows through the heating semiconductor, one end becomes hot and the other end becomes cool, so that a temperature difference is produced, that is, one end performs a heating function and the other end performs a refrigeration function, and the heating end of the heating semiconductor is connected to the second heat conduction assembly 72.

Optionally, as shown in FIG. 9, FIG. 10 and FIG. 11, a battery 5 configured to power the second circuit board 71 is further arranged in the handle 1, and the handle 1 is provided with a battery level display lamp 11 connected to the second circuit board 71.

The battery 5 is a rechargeable battery 5. The battery level display lamp 11 is configured to display a battery 5 level. The battery level display lamp 11 is exposed outside a casing of the handle 1, so that the user can observe the use of the battery 5 in time and charge the battery in time conveniently.

Optionally, as shown in FIG. 9, FIG. 10 and FIG. 11, the handle 1 is further provided with a switch button 12 connected to the second circuit board 71.

The switch button 12 is exposed outside a surface of the casing of the handle 1. When the blades 3 need to be heated, the user presses the switch button 12, and the second circuit board 71 controls the second heating bodies 73 to carry out heating. When a certain temperature is reached, the energy on the second heating bodies 73 is conducted to the second copper conductive sheet 723, the second copper conductive sheet 723 transfers the energy to the second aluminum conductive sheet 721, the second aluminum conductive sheet 721 conducts the energy to the second sheet metal connector 722, and the energy on the second sheet metal connector 722 is transferred to the blades 3, so that the temperature of the blades 3 finally rises.

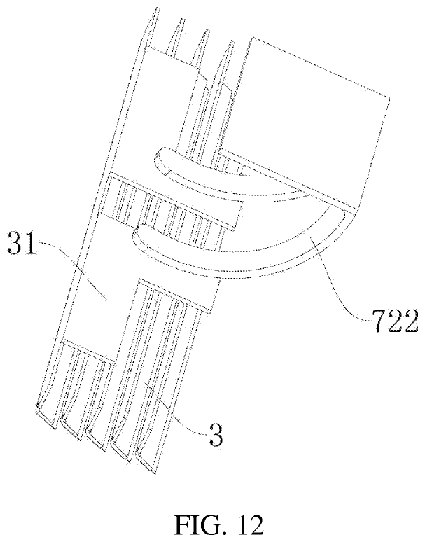

Optionally, as shown in FIG. 9, FIG. 10 and FIG. 12, the second heat conduction assembly 72 includes a second aluminum conductive sheet 721 and a second sheet metal connector 722 connected to each other. The second sheet metal connector 722 abuts against the blades 3.

The second aluminum conductive sheet 721 is made of aluminum, which has the advantages of light weight, low cost and good thermal conductivity and is less susceptible to oxidation. In addition, other materials with good thermal conductivity are also available. The second sheet metal connector 722 is made of stainless steel by sheet metal working, has certain elasticity and toughness, and is in the shape of a curved horseshoe. While the blade rest 2 rotates with respect to the handle 1, the second sheet metal connector 722 can be always in contact with the heat conduction brackets 31 on the blades 3. The second sheet metal connector 722 is thermally conductive, and can conduct heat with the blades 3.

In this embodiment, the second sheet metal connector 722 is arranged. On the one hand, the second sheet metal connector 722 has certain elasticity and toughness, so that the blade rest 2 can smoothly rotate with respect to the handle 1, and therefore, the blade rest 2 can be designed into a structure that can rotate with respect to the handle 1, which facilitates the user. On the other hand, the second sheet metal connector 722 has good thermal conductivity, so that the heat conduction structure can be always in contact with the blades 3 while the blade rest 2 rotates with respect to the handle 1, thereby effectively controlling the blades 3 to become hot.

Optionally, as shown in FIG. 9, FIG. 10 and FIG. 12, the second heat conduction assembly 72 further includes a second copper conductive sheet 723. The second copper conductive sheet 723 is arranged between the second aluminum conductive sheet 721 and the second heating bodies 73.

Two second heating bodies 73 arranged side by side are provided, and sides of the second heating bodies close to the second aluminum conductive sheet 721 are flush with each other. The second copper conductive sheet 723 is a copper sheet, which is generally rectangular or circular and is low in cost. In addition, other materials with good thermal conductivity are also available. The copper sheet has good heat conduction effect. Moreover, the copper sheet is soft and has certain ductility, and can be stretched when the second aluminum conductive sheet 721, and the second heating bodies 73 squeeze each other, so that contact areas of two side surfaces of the copper sheet with the second aluminum conductive sheet 721 and the second heating bodies 73 are maximized, which prevents the loss of energy during the transfer process, thereby ensuring a better overall heat conduction effect and improving the energy transfer efficiency.

Optional, as shown in FIG. 9 and FIG. 10, the handle 1 and the blade rest 2 are hinged with each other.

Two sides of one end of the handle 1 are respectively provided with rotating shafts, and the blade rest 2 is provided with mounting holes fitted with the rotating shafts. After the rotating shafts are fitted with the mounting holes, the blade rest 2 can rotate with respect to the handle 1 when stressed. In this embodiment, the handle 1 and the blade rest 2 are designed to be hinged with each other, so that the blade rest 2 provided with the blades 3 can rotate with respect to the handle 1, which facilitates the shaving of the user at various positions.

Optionally, as shown in FIG. 9, FIG. 10 and FIG. 12, the blades 3 are connected with heat conduction brackets 31, and the blades 3 are connected to the heating structure 7 in the heat conduction mode through the heat conduction brackets 31.

Multiple blades 3 are provided, and the blades 3 are arranged in parallel with each other at intervals. Two heat conduction brackets 31 are provided, each having a 7-shaped structure. Each heat conduction bracket 31 is connected to each blade 3, so that energy received by the heat conduction brackets 31 can be effectively transferred to each blade 3, and the mass of the overall structure of the blades 3 and the heat conduction brackets 31 can be minimized. The heat conduction brackets 31 are made of a thermally conductive material such as metal or ceramic, which has good thermal conductivity. In this embodiment, the heat conduction brackets 31 are additionally arranged between the blades 3 and the heating structure 7, so that the change of the temperature of the blades 3 is more stable and uniform when heated or cooled.

Optionally, as shown in FIG. 9, FIG. 10 and FIG. 12, the blades 3 are integrally formed with the heat conduction brackets 31.

One of the blades 3 is integrally formed with the heat conduction brackets 31, and the other blades 3 may be connected to the heat conduction brackets 31 by welding or bonding, which can reduce the mounting steps and ensure the heat transfer effect between the blades 3 and the heat conduction brackets 31.

Although the disclosure has been disclosed above, the protection scope of the disclosure is not limited thereto. Any person skilled in the art can make various changes and modifications without departing from the spirit and scope of the disclosure, and these changes and modifications fall within the protection scope of the present invention.

What is claimed is:

1. A manual razor having a temperature-changing function, comprising a handle (1) and a blade rest (2) connected to each other, wherein a blade (3) is mounted on the blade rest (2); and the handle (1) is provided with a heat transfer structure (4) configured to heat or refrigerate, and the heat transfer structure (4) and the blade (3) are connected to each other in a heat conduction mode; or the handle (1) is provided with a refrigeration structure (6), and the refrigeration structure (6) and the blade (3) are connected to each other in a heat conduction mode; or the handle (1) is provided with a heating structure (7), and the heating structure (7) and the blade (3) are connected to each other in a heat conduction mode; the blade (3) is connected with a heat conduction bracket (31), and the blade (3) is connected to the heat transfer structure (4) in the heat conduction mode through the heat conduction bracket (31); or the blade (3) is connected to the refrigeration structure (6) in the heat conduction mode through the heat conduction bracket (31); or the blade (3) is connected to the heating structure (7) in the heat conduction mode through the heat conduction bracket (31).

2. The manual razor having a temperature-changing function according to claim 1, wherein the handle (1) and the blade rest (2) are hinged with each other.

3. The manual razor having a temperature-changing function according to claim 1, wherein the blade (3) is integrally formed with the heat conduction bracket (31).

4. The manual razor having a temperature-changing function according to claim 1, wherein the heat transfer structure (4) comprises a circuit board (41), a heating body (43), a refrigerating body (44), and a heat conduction assembly (42) connected to the blade (3), the heating body (43) and the refrigerating body (44) being both electrically connected to the circuit board (41) and connected to the heat conduction assembly (42) in a heat conduction mode.

5. The manual razor having a temperature-changing function according to claim 4, wherein the heating body (43) is a heating semiconductor, and the refrigerating body (44) is a refrigerating semiconductor.

6. The manual razor having a temperature-changing function according to claim 4, wherein the heat conduction assembly (42) comprises an aluminum conductive sheet (421) and a sheet metal connector (422) connected to each other, the sheet metal connector (422) abutting against the blade (3).

7. The manual razor having a temperature-changing function according to claim 6, wherein the heat conduction assembly (42) further comprises a first copper conductive sheet (623), the first copper conductive sheet (623) being arranged between the aluminum conductive sheet (421) and the heating body (43) and refrigerating body (44).

8. The manual razor having a temperature-changing function according to claim 4, wherein a battery (5) configured to power the circuit board (41) is further arranged in the handle (1), and the handle (1) is provided with a battery level display lamp (11) connected to the circuit board (41).

9. The manual razor having a temperature-changing function according to claim 4, wherein the handle (1) is further provided with a switch button (12) connected to the circuit board (41), the switch button (12) comprising a heating button (121) and a refrigeration button (122).

10. The manual razor having a temperature-changing function according to claim 1, wherein the refrigeration structure (6) comprises a first circuit board (61), a first refrigerating body (64), and a first heat conduction assembly (62) connected to the blade (3), the first refrigerating body (64) being electrically connected to the first circuit board (61) and connected to the first heat conduction assembly (62) in a heat conduction mode.

11. The manual razor having a temperature-changing function according to claim 10, wherein the first refrigerating body (64) is a refrigerating semiconductor, and the refrigerating semiconductor is connected with a first heat dissipater (63).

12. The manual razor having a temperature-changing function according to claim 10, wherein the first heat conduction assembly (62) comprises a first aluminum conductive sheet (621) connected to the first refrigerating body (64) in a heat conduction mode.

13. The manual razor having a temperature-changing function according to claim 12, wherein the first heat conduction assembly (62) further comprises a first sheet metal connector (622) connected to the first aluminum conductive sheet (621), the first sheet metal connector (622) abutting against the blade (3), and the handle (1) and the blade rest (2) being hinged with each other.

14. The manual razor having a temperature-changing function according to claim 12, wherein the first heat conduction assembly (62) further comprises a first copper conductive sheet (623), the first copper conductive sheet (623) being arranged between the first aluminum conductive sheet (621) and the first refrigerating body (64).

15. The manual razor having a temperature-changing function according to claim 10, wherein a battery (5) configured to power the first circuit board (61) is further arranged in the handle (1), and the handle (1) is provided with a battery level display lamp (11) connected to the first circuit board (61).

16. The manual razor having a temperature-changing function according to claim 10, wherein the handle (1) is further provided with a switch button (12) connected to the first circuit board (61).

17. The manual razor having a temperature-changing function according to claim 1, wherein the heating structure (7) comprises a second circuit board (71), a second heating body (73), and a second heat conduction assembly (72) connected to the blade (3), the second heating body (73) being electrically connected to the second circuit board (71) and connected to the second heat conduction assembly (72) in a heat conduction mode; wherein the second heating body (73) is a heating semiconductor.

18. The manual razor having a temperature-changing function according to claim 17, wherein a battery (5) configured to power the second circuit board (71) is further arranged in the handle (1), and the handle (1) is provided with a battery level display lamp (11) connected to the second circuit board (71); wherein the handle (1) is further provided with a switch button (12) connected to the second circuit board (71).

19. The manual razor having a temperature-changing function according to claim 17, wherein the second heat conduction assembly (72) comprises a second aluminum conductive sheet (721) and a second sheet metal connector (722) connected to each other, the second sheet metal connector (722) abutting against the blade (3).

20. The manual razor having a temperature-changing function according to claim 19, wherein the second heat conduction assembly (72) further comprises a second copper conductive sheet (723), the second copper conductive sheet (723) being arranged between the second aluminum conductive sheet (721) and the second heating body (73).
